(19) United States
(12) Patent Application Publication
(10) Pub. No.: US 2017/0241037 A1
(43) Pub. Date: Aug. 24, 2017

(54) APPARATUS FOR ELECTROCERAMIC COATING OF HIGH TENSION CABLE WIRE

(71) Applicant: Henkel AG & Co. KGaA, Duesseldorf (DE)

(72) Inventors: Shawn E. Dolan, Sterling Heights, MI (US); Cody R. Davis, Maineville, OH (US); Ryan Anderson, Highland Heights, KY (US)

(21) Appl. No.: 15/425,404

(22) Filed: Feb. 6, 2017

Related U.S. Application Data
(63) Continuation of application No. PCT/US2015/044181, filed on Aug. 7, 2015.
(60) Provisional application No. 62/034,413, filed on Aug. 7, 2014.

(51) Int. Cl. C25D 11/00; C25D 11/06; H01B 9/00; C25D 11/18; H01B 13/00; C25D 11/02; C25D 11/16

(52) U.S. Cl. CPC C25D 11/005; C25D 11/026; C25D 11/06; C25D 11/16; C25D 11/18; H01B 13/0026; H01B 9/008

(57) ABSTRACT

The invention relates to an apparatus for continuously electrolytically coating a wire for a high tension cable for use in overhead transmission lines, wherein the apparatus comprises a bath for an aqueous electrolytic solution containing a precursor for an electro-ceramic coating on a wire, a first air knife cleaning device, an electrification device for electrifying the wire, a plurality of guide members positioned to route the wire from into, through and out of the bath, a cathodic connection positioned in the bath for contacting the aqueous electrolytic solution, and a power source electrically connected to the electrification device and the cathodic connection, said power source capable of providing high voltage and high current to the wire through the electrification device, and through the wire in the bath to the cathode connection via the aqueous electrolytic solution.

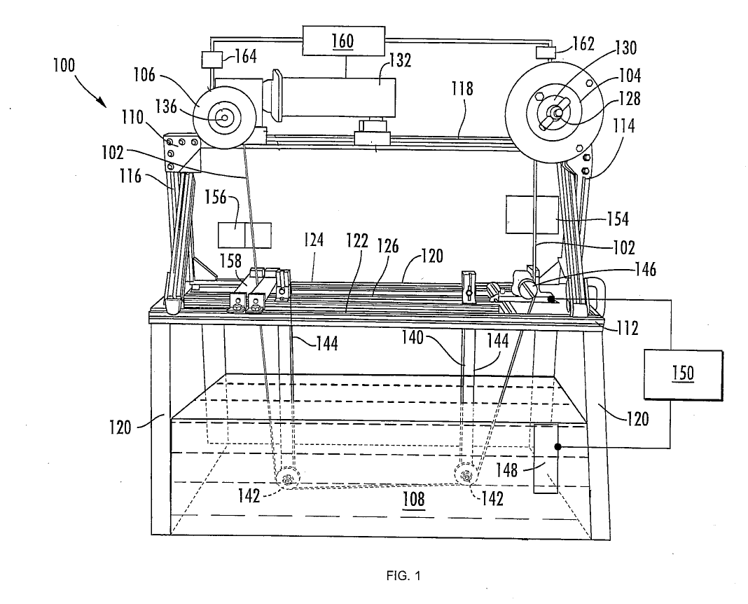

### BRIEF DESCRIPTION OF THE DRAWINGS

The FIGURE illustrates a schematic of an apparatus for coating a wire in a cable according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The FIGURE illustrates a schematic of an embodiment of an apparatus 100 for continuously coating a cable or a single wire or strand for a cable, such as a high tension electrical cable. The cable may have wires comprising aluminum or aluminum alloys. The wire 102 runs from a first spool 104 to a second spool 106. Each spool 104, 106 has a central barrel, or center cylindrical section, and may have flanges extending therefrom on either end of the central barrel. The first spool 104 provides a supply of uncoated, bare wire, such as aluminum, useful for example in a high voltage transmission cable, with the bare wire wound on the barrel of the spool 104. The second spool 106 receives the coated wire with the coated wire would on the barrel of the spool 106.

The wire 102 is fed through a bath 108 comprising a container at least partially filled with an aqueous solution comprising a precursor for a ceramic coating on the wire. The container for the bath 108 may be made from a material that is chemically unreactive with the solution. The container for the bath may be electrically conductive to provide a cathode, or may be made from electrically insulating and non-conductive material.

A first frame 110, or main frame, is supported above the bath 108. In one example, the first frame 110 has a lower sub-frame 112, first and second end supports 114, 116, and an upper frame member 118 or crossbar. The frame 110 may be made from metal tubing, or other materials, and in one example, the frame 110 is electrically conductive. Legs 120 may support the frame 110 on an underlying surface and above the bath 108. The lower sub-frame 112 may include first and second bars 122, 124 that are spaced apart from one another and may be generally parallel to one another. A central bar 126 is positioned between the first and second bars 122, 124. The first and second end supports 114, 116 may include a truss or the like.

The first spool 104 is supported by the upper frame member 118 or the first end support 114 by a stationary shaft 128. The spool 104 may be removed from the shaft 128 as needed for operation of the apparatus. A fastener may connect with the end of the shaft 128 to retain the spool 104 on the shaft 128 and allow for removal. The shaft 128 is positioned to be generally perpendicular with a section of the wire 102 as it leaves the spool 104, with the wire leaving the spool generally tangentially according to one example. A bearing assembly 130 is provided within the cylindrical section of the spool 104 and is sized to fit over the shaft 128 while reducing friction of the spool 104 as it rotates about the shaft 128.

An electric motor 132 is provided on the upper frame member 118. The electric motor may be a DC motor. The electric motor has a drive shaft 136.

The second spool 106 is supported by the drive shaft 136 of the electric motor 132. The spool 106 may be removed from the shaft 136 as needed for operation of the apparatus. A fastener may connect with the end of the shaft 136 to retain the spool 106 on the shaft 136 and allow for removal. The motor 132 shaft and the inner diameter of the spool 106 may be keyed or splined such that they rotate together.

In alternative embodiments, the electric motor 132 may be connected to the first spool 104, or each spool 104, 106 may be provided with an electric motor.

A second frame 140, or drop frame, is supported by the main frame 110 and extends away from the main frame 110 such that it may be received within the bath 108. In one example, as shown, the second frame 140 is connected to the central bar 126. The second frame 140 is positioned such that it is partially submerged within solution in the bath 108. The second frame 140 has at least one guide member 142 to guide the wire through the bath 108. In the example shown, the second frame 140 has first and second members 144 that drop from the first frame 110 with each frame member 144 having a guide member 142 connected to an end region. Each guide member 142 may be a wheel connected to the frame member 144 by a bearing connection, or may be a nonrotating guide member as is known in the art.

An electrical contact device 146 is supported by the main frame 110. The electrical contact device is positioned to contact the wire 102 away from or above the bath 108. The device 146 provides a dry anode connection to electrify the wire, and electrifies the entire length of the wire with a high voltage and a high current. The electrified wire 102 electrochemically reacts with the solution in the bath 108 to form a coating on the wire.

In one embodiment, the electrical contact device 146 is a dry anode connection providing at least 50 kW per wire. The electrical contact device may provide 50-60 kW to a single strand of wire in an example of the apparatus 100. In a further embodiment, the device 146 is a mercury switch having a wheel that rotates with the wire 102 as the wire is fed from spool 104 to spool 106. A mercury switch has a rotating connector with an electrical connection made through a pool of liquid metal molecularly bonded to the contact, which provides a low resistance, stable connection. As the mercury switch rotates, the fluid maintains the electrical connection between the contacts without wear and with low resistance. The mercury switch is able to provide the high voltage and high current needed to electrify the wire 102. According to one example, the high voltage is a peak voltage at or above 125 Volts, and the high current is a peak current at or above 450 Amperes and may be alternating current, asymmetric alternating current, direct current, or pulsed direct current. In alternative embodiments, a brushed slip ring, an electrified guide that the wire runs over, or other devices 146 may be used.

A cathode connection 148 is provided within the bath 108. The cathode connection 148 may be the container for the bath 108 itself if it is electrically conductive, a metal component, i.e. a plate or tube, positioned within the bath and in contact with the anodizing solution, or a salt bridge. The electrical contact device provides a dry electrical connection with the wire, as the solution in the bath is not sufficiently conductive to provide a wet anode connection and a voltage drop would occur. The device 146 and the cathode connection 148 are connected to a power supply 150. The power supply 150 may be controlled to provide alternating current to the anode and cathode, and may be high frequency such as 200-10,000 kHz; or may provide asymmetric alternating current, for example, with 400-500 Volts at the anode, 40-50 Volts at the cathode, and a square wave form pattern with a frequency of 0.1-40 milliseconds. In other examples, the power supply may provide direct current or pulsed direct current to the anode and cathode.

In one example, at least one cleaning device 154 may be positioned to interact with and clean the wire 102 before it enters the bath 108. The cleaning device 154 may be supported by the frame 110. The cleaning device 154 may be an air knife that forces pressurized air across the wire as the wire is fed past the air knife to remove any debris. The cleaning device 154 may also be a spray system that sprays pressurized fluid, such as deionized water, distilled water, a solvent such as an alcohol solution, or the like across the wire as the wire is fed past the cleaning system to remove any debris or other undesirable material from the surface of the bare wire, such as cutting fluid, etc. In other examples, the bare wire is sufficiently clean such that no cleaning device is needed for use with the apparatus 100.

In another example, an air knife 156 or another similar device is positioned to interact with the wire 102 after it exits the bath 108. The air knife 156 may be supported by the frame 110. The air knife 156 provides pressurized air across the wire as the wire is fed past the air knife to remove any excess solution on the surface of the coated wire after it exits the bath. A collection system may be adjacent to the air knife 156 to collect the excess solution and return it to the bath 108 in a recycling process. In other examples, an air knife is not used with the apparatus 100 based on a low or negligible amount of solution on the surface of the coated wire.

One or more sets of guides 158 may be provided on the first frame 110 or the second frame 140 to guide the wire 102 to travel along a predetermined path between the first spool 104 and the second spool 106. The guides 158 may be roller guides, including one or two plane guides, or the like. The guides 158 may assist in directing the wire to pass by the cleaning device 154 and/or the air knife 156. The guides 158 may assist in a smooth feed of the wire from the first spool 104. The guides 158 may also present the wire at the appropriate angle to the second spool 106 for a smooth winding.

A controller 160 is in communication with the electric motor 132. The controller 160 may be a single controller or multiple controllers in communication with one another. The controller 160 may be connected to random access memory or another data storage system. In some embodiments, the controller 160 has a user interface. The controller 160 is configured to control the electric motor 132, the power supply 150, and the cooling system 152 for startup procedures, shut down procedures, and emergency stop procedures.

In one embodiment, the controller 160 is in communication with a first sensor 162 and a second sensor 164. The first and second sensors 162, 164 are used with the first and second spools 104, 106, respectively. The first and second sensors 162, 164 may be position sensors for wire tracking.

The controller 160 controls the speed of the electric motor 132 to control the speed of the second spool 106 and the feed speed of the wire through the apparatus. By controlling the feed speed of the wire 102, the residence time of the wire within the bath 108 is controlled. In one embodiment, the controller 160 controls the motor 132 speed to maintain a residence time within a predetermined range or at a predetermined speed. In one example, the residence time is approximately five to ten seconds and/or the feed speed is 100 feet per minute. As the amount of wire on the first spool 104 (and the diameter of the wrap of wire) decreases, the spool must spin faster to provide the same feed rate of wire through the bath. Likewise, as the amount of wire on the second spool 106 (and the diameter of the wrap of wire) increases, the spool 106 must spin slower to provide the same feed rate of wire through the bath.

As the apparatus 100 is operated, bare wire leaves the spool 104 and travels over the electrical contact device 146 and is electrified with a high current and a high voltage via a dry anode connection. The wire may be an aluminum or aluminum alloy wire in an embodiment. The bare wire then enters the bath 108. In one example, the bath contains an aqueous electrolytic solution containing at least one of a complex fluoride and an oxyfluoride. In other examples, other solutions as disclosed herein may be used. The wire electrochemically reacts with the precursor in the bath by passing a current between the wire in the bath and a cathode in the bath to form the coating. This reaction forms a visible light-emitting discharge adjacent to the wire (or an oxygen plasma) and a hydrogen gas from the water in the aqueous solution. The electrified wire may form a plasma with the liquid precursor, with the bath acting as a cathode and the wire acting as an anode. A coating is formed on the bare wire, and the coating may be a metal/metalloid oxide electro-ceramic. The coating has an emissivity greater than that of the bare wire. The thickness of the coating is controlled via the residence time of the wire within the bath.

The continuous length of the wire 102 may be electrified, as the wire is made of a highly conductive material and designated for use in electrical cable. As such, the first spool 104, the frame 110, and various guides or devices on the frame 110 may also be electrified. The wire acts as an anode in the bath 108.

The second spool of coated wire 102 may be removed from the apparatus 100 and used to form a high voltage transmission or distribution cable. Multiple spools of coated wire may be combined or bundled to form a cable. Additionally, bare wire and/or support wires may be added to the cable assembly. In one example, bare wires and support wires are internal wires in the cable, and the coated wires form the outer perimeter wires of the cable. The various wires of the cable may be tensioned to provide a predetermined degree of twist. The cable may be installed on a tower or in the electrical grid for use transmitted high voltage electrical power, and as such the outer coated surface of the cable formed by the coated wires interacts with the environment to cool the cable by emitting radiation, including radiation in the infrared wavelength.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for continuously electrolytically coating a wire for a high tension cable for use as an overhead transmission line, the apparatus comprising:
a bath for an aqueous electrolytic solution containing a precursor for an electro-ceramic coating on a wire;
a first spool frame member adapted to support a first spool for providing the wire to the bath;
a second spool frame member adapted to support a second spool for receiving the wire from the bath;
a first air knife cleaning device capable of forcing pressurized air across the wire as the wire is fed past the air knife cleaning device to remove debris or solution from the wire;
an electrification device for electrifying the wire and located between the first spool frame and the bath;
a plurality of guide members positioned to route the wire from the first spool to electrically engage with the electrification device, pass into, through and out of the bath, and be rewound around the second spool;
at least one motor adapted to move the wire from the first spool, through the plurality of guide members and rewind the wire around the second spool;
a cathodic connection positioned in the bath for contacting the aqueous electrolytic solution; and
a power source electrically connected to the electrification device and the cathodic connection, said power source capable of providing high voltage and high current to the wire through the electrification device, and through the wire in the bath to the cathode connection via the aqueous electrolytic solution.

2. The apparatus of claim 1 wherein the electrification device is a dry anode connection providing at least 50 kW per wire.

3. The apparatus of claim 1 further comprising a controller connected to and configured to control at least the at least one motor.

4. The apparatus of claim 1 wherein the controller is connected to the motor and configured to control a speed of the motive assembly for controlling speed of the wire to maintain a residence time of the wire in the bath.

5. The apparatus of claim 1 wherein during use the electrified wire contacts the aqueous electrolytic solution, the high voltage and high current passes from the electrified wire acting as an anode to the cathodic connection, thereby forming a plasma around the wire with the precursor in the solution, resulting in electro-ceramic coating deposition.

6. The apparatus of claim 1 wherein the first air knife is positioned to interact with and remove debris from the wire before the wire enters the bath.

7. The apparatus of claim 1 wherein the first air knife is positioned between the bath and the second spool to remove excess liquid from the wire before the wire reaches the second spool.

8. The apparatus of claim 1 wherein the first air knife is positioned to interact with and remove debris from the wire before the wire enters the bath; and further comprising a second air knife positioned between the bath and the second spool to remove excess liquid from the wire before the wire reaches the second spool.

9. The apparatus of claim 1 wherein the precursor in the aqueous electrolytic solution comprises at least one of a complex metal fluoride and a metal oxyfluoride.
